(19) United States
(12) Patent Application Publication
(10) Pub. No.: US 2003/0224847 A1
(43) Pub. Date: Dec. 4, 2003

(54) Method and apparatus for playing a keno, lottery or bingo-style sports game

(76) Inventor: Scott Jaimet, Tigard, OR (US)

Correspondence Address: WEIDE & MILLER, LTD., 7251 W. LAKE MEAD BLVD., SUITE 530, LAS VEGAS, NV, 89128, US

(21) Appl. No.: 10/411,018

(22) Filed: Apr. 9, 2003

Related U.S. Application Data
(60) Provisional application No. 60/371,993, filed on Apr. 10, 2002.

(51) Int. Cl. A63F 13/00

(52) U.S. Cl. 463/16; 463/18; 463/19

(57) ABSTRACT

The invention comprises a Keno, lottery or Bingo-style game comprising the steps of a player placing a wager or bet to play the game, selecting or generating a set of player numbers from a set of possible game numbers, and representing the outcomes of various sports events as game numbers from the set of game numbers, and then determining the outcome of the game by comparing the player numbers to the winning numbers representing the outcomes of the sports events. If a sufficient number of the numbers match or matches in specific combinations or patters are received, the player is declared a winner of the game.

### RELATED APPLICATION DATA

This application claims priority to U.S. Provisional Patent Application Serial No. 60/371,993, filed Apr. 10, 2002.

### FIELD OF THE INVENTION

The present invention relates to a method of playing a game and, more particularly, to a method of playing a variation of Keno, lottery or Bingo.

### BACKGROUND OF THE INVENTION

The game of Keno is a traditional game that is very popular amongst patrons of casinos and other gaming establishments. In the traditional game of Keno, a game board containing the numbers 1-80 is displayed to a player. The player then selects a predetermined number of those numbers. Twenty numbers are then randomly chosen and compared to the numbers selected by the player to determine the number of matches and whether the player is a winner. The number of numbers which the player is permitted to select may vary. Based upon the number of numbers selected and the number of matches, the outcome of the game is a winning or losing outcome. Generally, the higher number of matches, the more likely the outcome will be a winning outcome and the greater the amount of winnings which will be paid.

It will be appreciated, however, that there is little variation to the traditional game of Keno. The player's choices in playing the game are generally limited to deciding how many numbers to choose and which numbers to choose. As a result, play of the traditional game of Keno can quickly lose its excitement to a player.

On the other hand, Keno does have the advantage that it is easy to understand and play. Thus, a large number of gamblers play, or have played, the game at one or more times.

Lotteries and Bingo have similar attributes to Keno. In a lottery, players select or are assigned sets of numbers from a larger set of numbers. A winning set of numbers is then generated and compared to the player's set to determine if matches exist. In Bingo, a player is provided with a set of numbers organized in a grid, such as on a display or printed card. Game numbers are then selected and compared to the player's numbers. A player attempts to obtain matches.

Lotteries and Bingo have wide appeal because they are easy to play. In the case of lotteries, because the odds of matching all of the numbers is low, jackpots can grow very large, creating a great deal of player excitement. In the case of Bingo, multiple games can be played by a player simultaneously, lending to the excitement of the game. Unfortunately, as with Keno, lotteries and Bingo can have little excitement or lose their excitement in everyday play. For example, in the case of a lottery, unless a large jackpot exists, many players find participation very unexciting.

### SUMMARY OF THE INVENTION

The invention comprises Keno, lottery and Bingo-style games. In general, each of these games is associated in some way with one or more external events. In a preferred embodiment, the events are sporting events. The outcomes of the sporting events defines, at least in part, the outcome of the Keno, lottery or Bingo-style game.

In one embodiment, the game comprises the steps of a player placing a wager or bet to play the game. A set of player numbers is then selected or generated from a set of possible game numbers. The outcomes of various sports events are represented as winning numbers from the set of game numbers. The outcome of the game is determined by comparing the player numbers to the winning numbers representing the outcomes of the sports events. If a sufficient number of the numbers match, the player is declared a winner of the game.

In one embodiment, the outcome of the sports event is determined by the score of the event, such as by adding or combining the scores of the teams or players. In one embodiment, the game numbers comprise a range of numbers. The player numbers comprise a sub-set of the game numbers.

In one embodiment, game cards are printed indicating the game numbers, sports events, player numbers and other information. In one embodiment, the game may be presented via a computer network, such as via the Internet. Player numbers may be generated randomly using a computer.

In one embodiment, the game is implemented in a Keno-style format. In one embodiment, a card is printed which bears a complete set of game numbers. A sub-set of player numbers are indicated from the set of game numbers. The outcome of one or more sporting or other events are used to define a winning set of numbers from the game numbers. The winning set of numbers is compared to the player's numbers to determine if matches exist. The number of matches, if any, determines if the player is the winner of the game. In this embodiment, the game of the invention combines the attributes of Keno with the excitement of sports betting.

In another embodiment, the game is implemented in a Bingo-style format. In one embodiment, a card includes a grid of randomly assigned numbers selected from a set of game numbers. The outcome of one or more sporting or other events are used to define a winning set of numbers from the game numbers. The winning set of numbers is compared to the numbers in the grid of numbers on the player's card. If a predetermined pattern of matches, such as a row, column, or diagonal, is received, then the player is a winner of the game. In this embodiment, the game of the invention combines attributes of Bingo with the excitement of sports betting.

In another embodiment, the game is implemented in a lottery-style format. In one embodiment, a player selects or is assigned a set of numbers from a set of game numbers. In one embodiment, the game numbers are associated with teams or other aspects of sporting events. The outcome of the sporting or other events comprises or determines a set of winning numbers. The number of matches, if any, between the winning numbers and the players numbers determines if a winning outcome is received. In this embodiment, the game of the invention combines the attributes of a lottery with the excitement of sports betting.

Further objects, features, and advantages of the present invention over the prior art will become apparent from the detailed description of the drawings which follows, when considered with the attached figures.

### DESCRIPTION OF THE DRAWINGS

FIGS. 1A and 1B illustrate a game card for professional football sports events in accordance with an embodiment of a Keno-style game of the invention;

FIGS. 2A and 2B illustrate a game card for professional basketball sports events in accordance with an embodiment of a Keno-style game of the invention;

FIGS. 3A and 3B illustrate a game card for professional baseball sports events in accordance with an embodiment of a Keno-style game of the invention;

FIGS. 4A and 4B illustrate a game card for professional hockey sports events in accordance with an embodiment of a Keno-style game of the invention;

FIG. 5 illustrates a game card for a Bingo-style game of the invention; and

FIG. 6 illustrates a game card for a lottery-style game of the invention.

### DETAILED DESCRIPTION OF THE INVENTION

The invention is a method for playing a Keno, lottery or Bingo-style game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a method for playing a game that associates sporting events with a game of Keno, Bingo or lottery. Various specific versions of the game are described below. It will be appreciated that other variations are contemplated as within the scope of the invention.

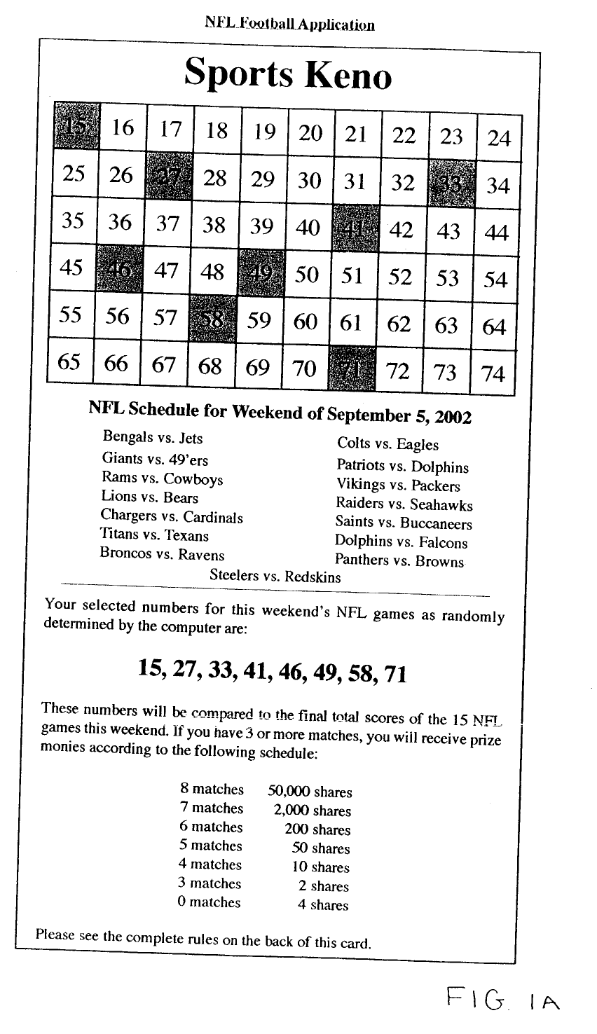

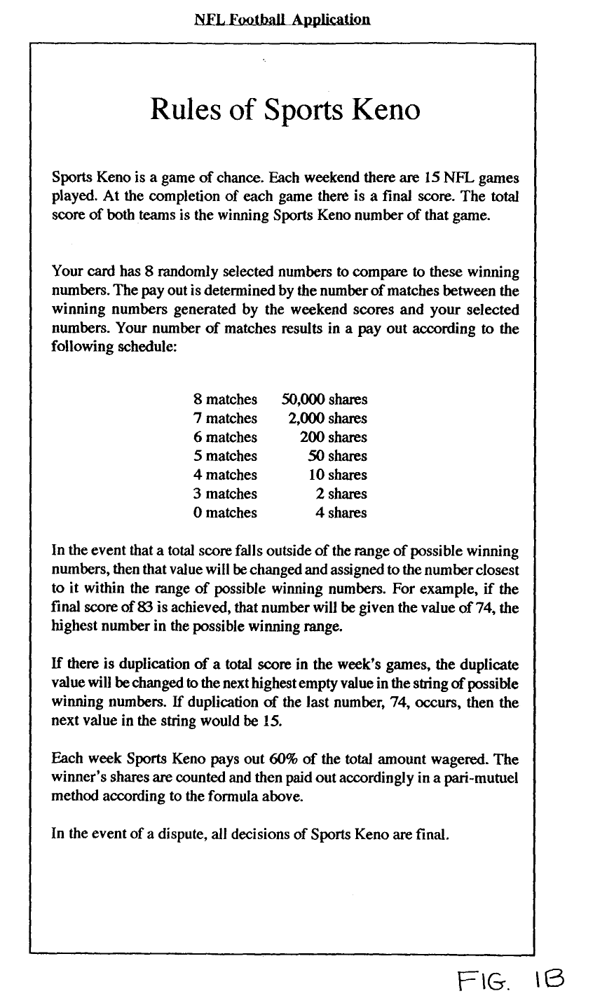

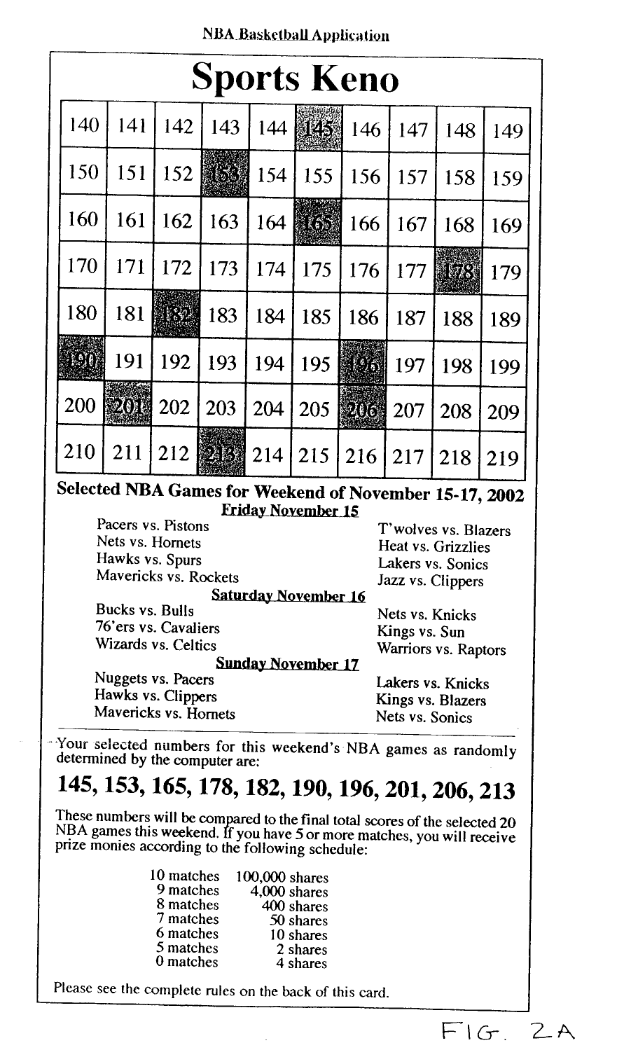

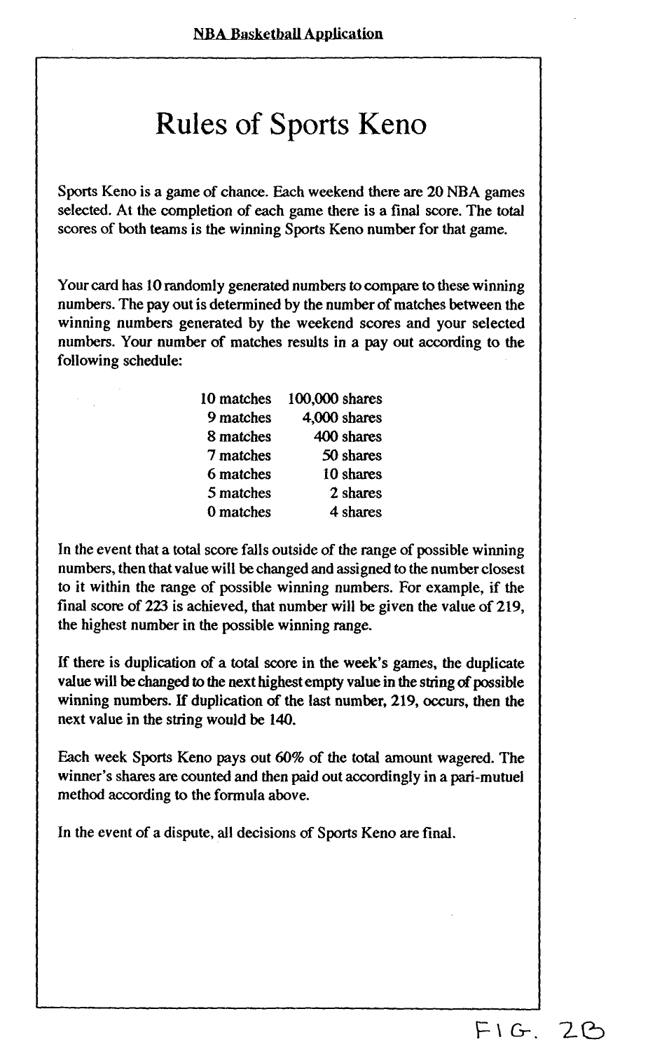

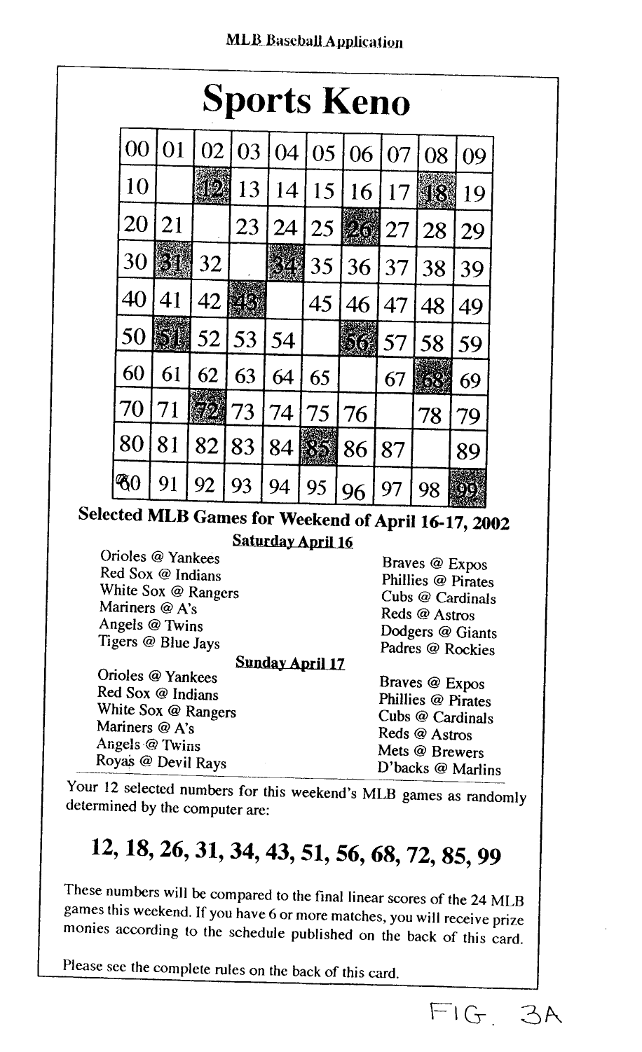

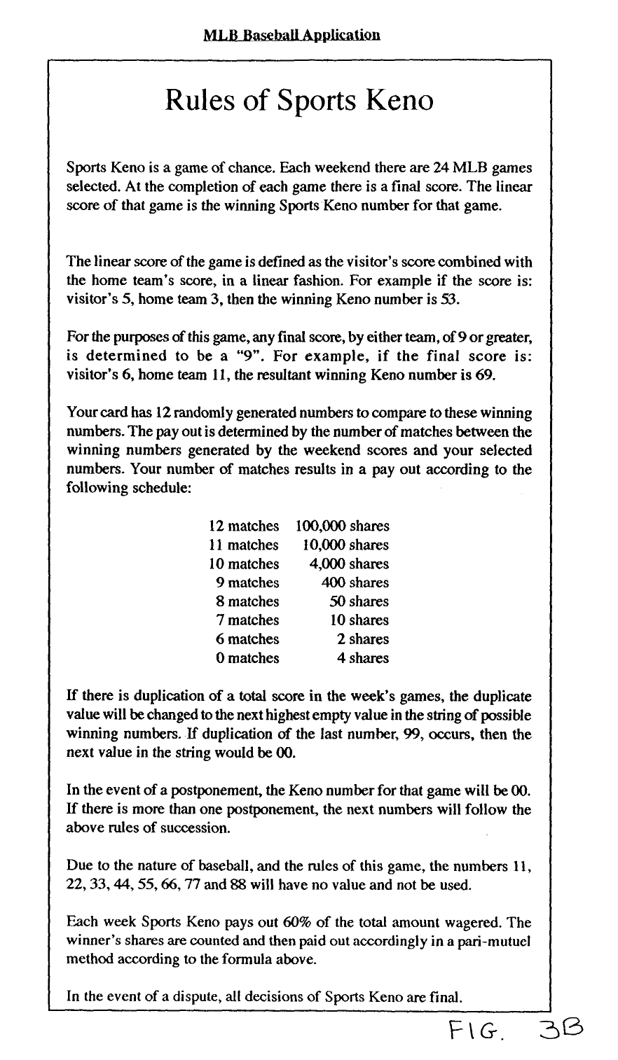

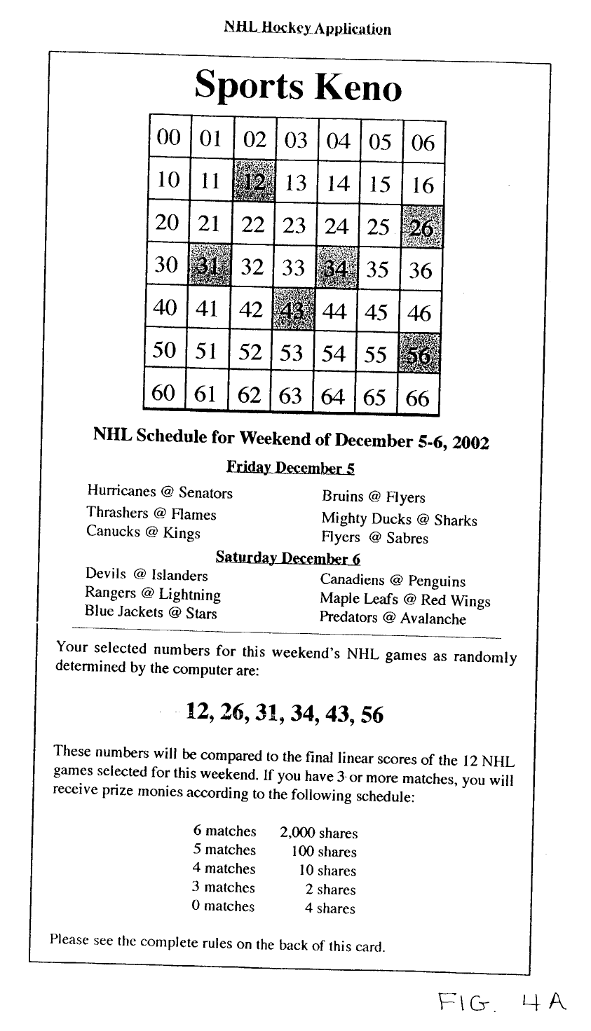

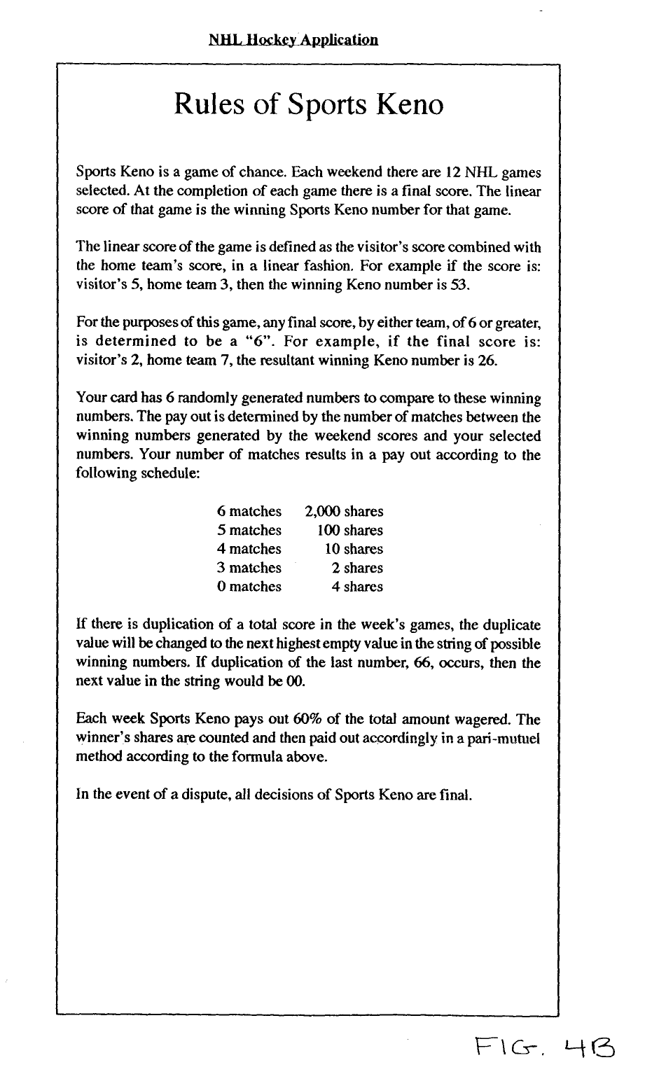

One embodiment of the invention will be described with reference to FIGS. 1A to 4B. In accordance with this embodiment of the invention, a Keno-style game is provided.

In one embodiment of such a game, a set of player numbers are generated or selected. These numbers are selected from a set of game numbers. The outcomes of various sports events are each represented as winning numbers comprising one or more of the game numbers. The outcome of the game is determined by comparing the winning numbers representing the outcomes of the sports events with the player numbers. The goal of the game is to match as many player numbers with the winning numbers which represent the outcomes of the sports events. If a sufficient number of matches result, the player is declared a winner of the event, and in one embodiment is paid a winning.

In one embodiment of the invention, a player is presented with a game card or board. The game card in one embodiment comprises a computer generated printout. In one embodiment, the game card displays a game number board, a sports schedule, a player's numbers and a payout schedule. Various embodiments of game cards or boards for different types of sports events are illustrated in FIGS. 1A-4B. Aspects of these game cards are described in greater detail below.

In a preferred embodiment, the sport schedule comprises a plurality of sports events (i.e., football games, basketball games, baseball games). In one embodiment, the sports events may be during a specific period of time (i.e., Week 2 of the NFL Schedule, MLB weekend games for April 15-16). In one embodiment, each of the sports events are of the same type (i.e., all baseball games).

The sports events may comprise a wide variety of events, such as boxing, golf, hockey and others. The sports events may involve teams or players or other participants (e.g. horses, dogs).

In a preferred embodiment, the game number board is a predetermined set or range of numbers or values that represent a possible outcome of each of the events comprising the sport schedule. As described below, the game numbers or values may be selected based upon a variety of criteria and may comprise any of a variety of sets of numbers.

In one embodiment, the number of game numbers is determined by a predetermined equation. In one embodiment, the equation requires multiplying the total number of events comprising the sport schedule by 4. For example, if 15 events are listed in the sport schedule, the number 15 is multiplied by 4 to determine the range or, in this embodiment, the total number of game numbers which are displayed. The total number of values displayed on the game number board in this example would be 60.

In another embodiment, the number of game numbers displayed is not fixed or determined by the above-referenced equation, but may be determined by other means. For example, the total number of game numbers may be selected randomly.

In one or more embodiments, the particular game numbers may vary. In one embodiment, the game numbers are sequential. For example, in the case where the number of game numbers is 60, the actual game numbers may be 1-60 or 15-74.

Preferably, the particular game numbers comprise numbers which may represent the outcome of a particular sports event. In one embodiment, the outcome of a particular sports event is represented as a numerical number/value comprising the sum of the scores of each team or player. For example, if the sports event is a game of professional football and the final score is 15-12, the outcome may be represented by the value 15+12=27. The score or other outcome of the sports event may also be converted into a winning number in other manners. For example, the scores of the teams may be “merged” to comprise a single value. If the final score in a game of baseball is 3-1, then the outcome may be represented by the value 31.

In one or more embodiments, the particular game numbers are based solely on the type of sports events or other criteria. For example, past outcomes of scores for the particular event could be used to establish the possible game numbers displayed on the game number board. For example, in the game of professional football it may be determined that the total of the scores of the teams for each game is rarely below 15 and rarely above 74. The game numbers may then be selected to be the 60 numbers between the values 15 and 74.

Each set of game numbers has a low or base number and a high or top number. Each of these numbers, like all the numbers comprising the game numbers, may be determined in more than one manner. In one embodiment, the top or highest number may be generated by adding the number of numbers to be used (such as 60) to the lowest selected number. For example, if the lowest number is to be 15 and the number of numbers is to be 60, then the top number (if the numbers are sequential) will be 74. In another embodiment, the top or highest number is determined by past scoring results in the particular event. Likewise, the base or lowest number is preferably determined by past scoring results in the particular event.

Based upon the sports event, the game numbers may exclude certain numbers. For example, the numbers 11, 22, 33 and the like may not be used when the events are professional baseball games with their outcomes represented by the combined or “merged” scores of the two teams, since the games can not end in a tie (i.e., no game outcome can be 1-1 or 2-2).

It will be appreciated that in some instances, depending upon the particular game numbers selected for use in playing the game, the outcome of a particular sports event may be represented by a value not comprising one of the game numbers. For example, the outcome of the sports event may comprise a number which is above or below the range of game numbers. For example, if the game numbers for a set of professional football games is 15-74, and in one game the final score is 10-0, then the value 10 would not fall within the range of the game numbers.

In one or more embodiments, means are provided for representing the outcome of such a sports event with a game number which is not within the range. In one embodiment, if the outcome of the sports event is a number which is higher than the highest or top value of the game numbers, then the sports event outcome is assigned that highest value. Likewise, if the outcome of the sports event is a number which is lower than the lowest value of the game numbers, then the sports event outcome is assigned that lowest value.

It will also be appreciated that the outcome of multiple sports events may comprise the same game number, or be assigned the same game number in accordance with the above-rules. For example, two professional football games may have the outcomes of 28-21 and 42-7, or a single value of 49. In one or more embodiments of the game, the outcomes of the sports events are all assigned different numbers or values. In one embodiment, a duplicate outcome value is assigned the next highest (or in other embodiments, lowest) number from the game numbers. In some instances, the next “highest” value may actually be the lowest number or value.

The player numbers may be selected or generated in a variety of manners. Preferably, however, the player numbers comprise a set of numbers selected from the various game numbers. In one or more embodiments, the player numbers are randomly generated, such as by a computer. In another embodiment, a player may select his or her own numbers.

The number of selected or generated player numbers may vary. The set of player numbers may depend, for example, upon the total number of game numbers. Generally, the total number of player numbers may increase as the total number of game numbers increases. Further, like the game of Keno, the total number of player numbers may vary in a single game. For example, the number of player numbers may be 5 or 10. As described below, however, like in Keno, the number of matches required for a winning outcome or the amount of winnings awarded may depend upon the number of player numbers.

In one or more embodiments, the number of player numbers is fixed and equal to one-half (½) (or rounded to the next whole number) of the total number of sports events comprising the sport schedule. It will be appreciated that in one or more embodiments, the set of player numbers may be greater or less than one-half (½) of the sport events comprising the sport schedule.

In one embodiment, the selected or generated player numbers may be indicated to the player. For example, the player numbers may be displayed to the player by highlighting the selected player numbers on the game number board located on the game card, or by listing the selected player numbers on the game card. Of course, other means may be provided for indicating or displaying the player numbers, including on a game card or otherwise.

In accordance with the invention, the player numbers are compared to the numbers representing the outcomes of the sports events to determine the winner. The outcome of one or more of the sports events is defined as a winning number, preferably generating a set of winning numbers, the set of winning numbers comprising a sub-set of the game numbers. The goal of the game is to match as may of the player numbers with as many of the winning numbers representing the outcomes of the sports events as possible.

The game may be declared a winning outcome if a sufficient number of the player numbers match the winning numbers representing the outcomes of the sports events. In one embodiment, a predetermined number of matches may be required. Winnings may be paid for winning outcomes. In one embodiment, the player is required to place a bet in order to play the game, and the winning payouts increase for increasing numbers of matches. In one embodiment, the payout schedule is printed on the game card.

It will be appreciated that the player numbers should be selected before the sports events occur. A cut-off time for placing bets or wagers may be set for this purpose.

In one or more embodiments, the invention comprises a system and apparatus for implementing the methods of the invention. In one embodiment, the system and apparatus comprise a computer system. The computer system in a preferred embodiment consists of a host or main computer. The host is preferably arranged to receive input and generate an output. In one or more embodiments of the invention, the host includes one or more systems or modules (including hardware and/or software) for generating the set of game numbers, and for generating or accepting as input the player numbers, for generating or accepting as input the one or more winning numbers, and determining matches and winning outcomes.

For example, one embodiment of the invention may be implemented over the Internet or other communication network. A player may place a bet, such as by electronic financial transaction. The game numbers and the sports events and odds/game rules and the like may be displayed. The player may input his or her player numbers selections, or the player numbers may be automatically generated. The player numbers may be displayed to the player, such as on his or her computer display. A game ticket or card may also be printed and sent to the player or the player may download and print the ticket at his or her location. Game outcome information may be accessible to the player at the end of the game.

In one embodiment, the games of the invention may be played by a player accessing a home computer, kiosk or other station, the station communicating at one or more times with a main computer or server. For example, a kiosk may be located in a casino sports-book. The player may utilize the kiosk to place a wager and then receive a game card. The game card may be similar to that illustrated in the figures. In one embodiment, the game card may also include a bar code or other machine-readable identifier. At the outcome of the sports events, the player may input their game card for identification at the kiosk. The identifier on the card may be used to locate stored game card information. For example, the kiosk may transmit the identifier to the main server. The stored game card information, including the set of player numbers associated therewith, may then be compared to the set of winning numbers. The outcome of the player's card may then be determined. If the outcome is a losing outcome, the player may be so notified, such as by text on a display screen. If the outcome is a winning outcome, the player may be instructed how to redeem their game card for winnings or the player may be issued (by generating/printing at the kiosk) a ticket which is representative of value.

Of course, the games of the invention may be implemented in a variety of other fashions using a variety of systems and devices.

Another embodiment of the invention comprises a Bingo-style game. In one embodiment, a set of game numbers is provided. The game numbers may be generated in a variety of manners, and may or may not be sequential. A player is assigned a set of player numbers, the player numbers randomly selected from the game numbers. Preferably, fewer player numbers are selected than there are game numbers, but in another embodiment all of the game numbers may be selected.

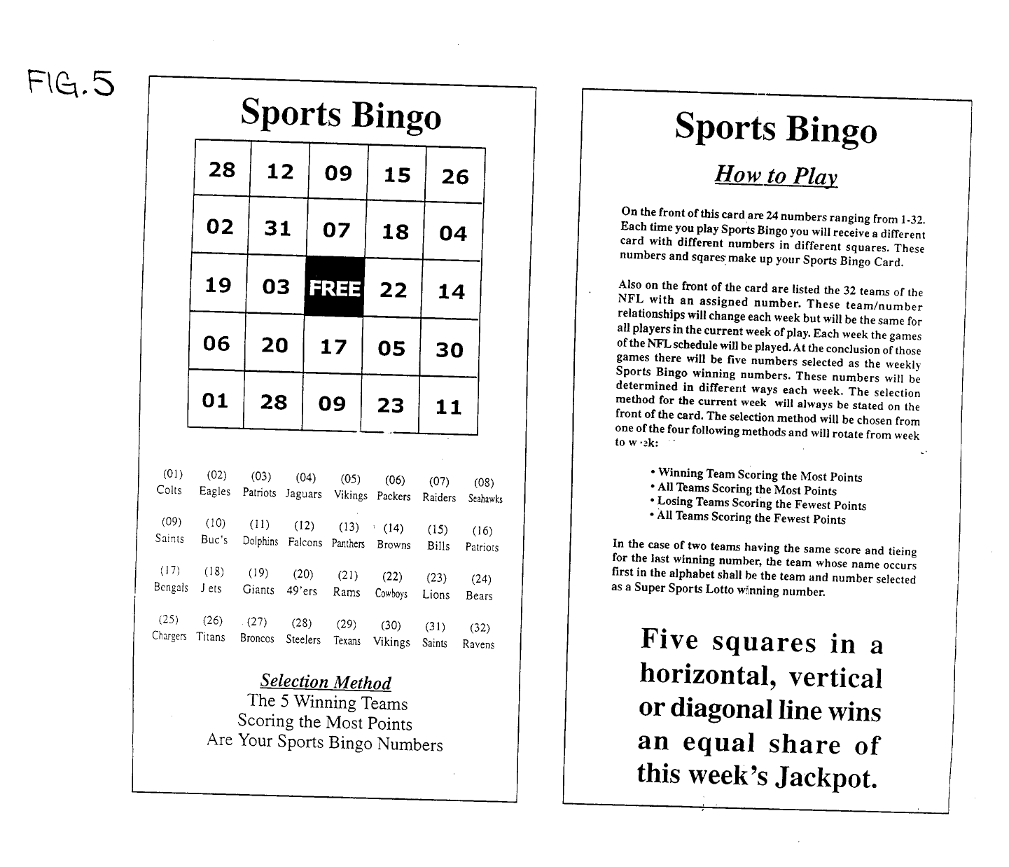

The player numbers are displayed in a pattern, and preferably in a matrix or grid format. As illustrated in FIG. 5, the matrix may be 5×5. The matrix may be of other sizes, n×m, where n and m may be the same or different numerical values. The numbers may also be displayed in other than an orthogonal grid.

In one embodiment, the player numbers are displayed by printing them on a card, in similar fashion to a Bingo card. The player numbers might also be displayed, such as on a video display. Preferably, the player numbers are randomly assigned to the display positions (i.e., grid or other positions).

A set of winning numbers is defined by the outcome of one or more events. Preferably, the events are sporting events.

As described above, a wide variety of ways may be used to define a set of winning numbers from one or more sports or other events. In the embodiment illustrated in FIG. 5, each team in a slate of football games is assigned a game number. The 5 winning teams which score the most points are defined to be the winning teams, and the winning numbers are the numbers assigned to those winning teams. In this embodiment, game numbers are assigned to sports events or participants thereof. These game numbers become winning numbers based upon the outcomes of the sports events. It will thus be appreciated that there are a wide variety of ways that the outcomes of one or more sports events may be used to define one or more winnings numbers for use in determining the outcomes of the games described herein.

As described above and as indicated in FIG. 5, a wide variety of other criteria may be used for defining the winning numbers, such as losing teams scoring the fewest points, teams scoring the most points and teams scoring the fewest points. As also indicated above, the criteria may vary dependent upon the particular event.

The outcome of the game is determined by comparing the winning number to the player's numbers. A winning outcome is received if one or more combinations of player numbers match the winning numbers.

In the preferred embodiment, a winning outcome is received if a predetermined pattern of matches occurs. The predetermined pattern may comprise any row, any column, and/or any diagonal of the numbers in the grid format illustrated in FIG. 5. Of course, other combinations may be defined as winning combinations or patterns, such as “X”, “T” and others, as known in the game of Bingo. If the player numbers are not displayed in a matrix, other winning combinations may be defined. For example, the numbers may be arranged in a pyramid, and winning combinations may comprise all numbers along a side or the base of the pyramid or other “payline.” A “payline” may be define as a set of positions which, if matches occur therealong, comprises a winning combination.

In the preferred embodiment, the game is implemented as a wagering game. A player places a bet or wager to play the game. In one embodiment, a player places a bet to obtain a set of player numbers (such as a player card).

If the player receives a winning outcome, the player may be paid winnings. In one embodiment, some or all of the wagers placed by players is put into a jackpot pool. All players receiving winning combinations split the jackpot pool. Other criteria may be applied, however, for paying winnings. For example, a player may be paid pre-set or predefined winnings. In one embodiment, a player might be paid $X for a single winning combination, but a larger $Y for multiple winning combinations.

As illustrated, one or more “free” or wild symbols may be provided, as is known the art of Bingo. In addition, a player may use a mechanical dauber to mark matching numbers on his or her card, or in the case of video displayed numbers, matches may be indicated visually with color or other display means.

In similar fashion to the Keno-style game above, a variety of variations to the game are possible. Further, one aspect of the invention comprises apparatus for implementing the game. The apparatus may comprise a computer system or network including displays and/or may include printed cards. As in the case of the Keno-style game, data regarding sets of player numbers may be stored in files or other formats. Input may be provided regarding winning numbers, and matches may be determined by comparing the inputs to the data sets.

Another embodiment of the invention comprises a lottery-style game. In one embodiment, a set of game numbers is provided. The game numbers may be generated in a variety of manners, and may or may not be sequential. A player is assigned a set of player numbers, the player numbers randomly selected from the game numbers. Fewer player numbers are selected than there are game numbers.

A set of winning numbers is defined by the outcome of one or more events. Preferably, the events are sports or sporting events.

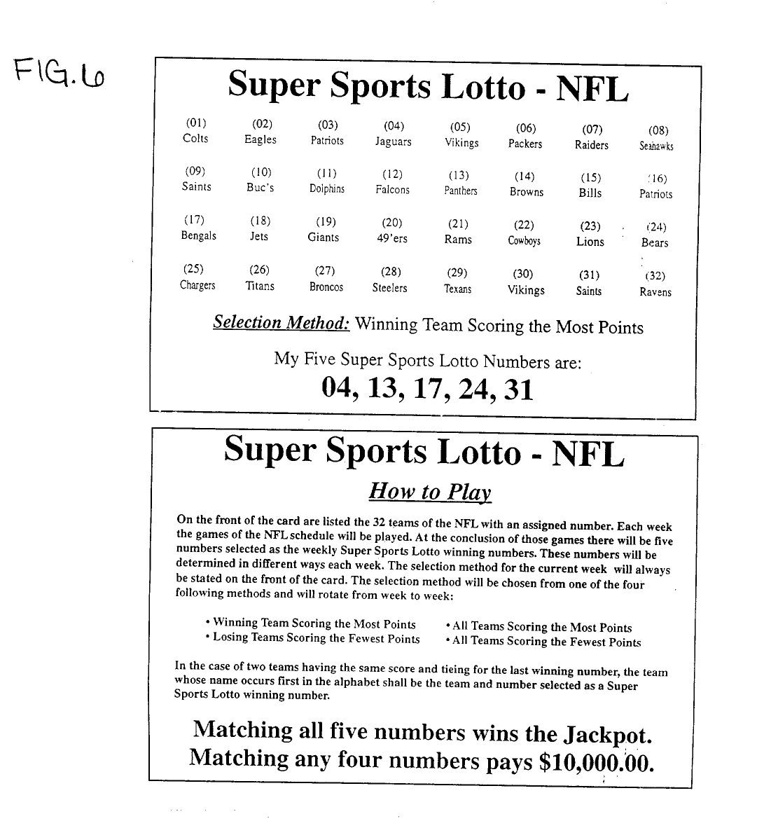

As described above, a wide variety of ways may be used to define a set of winning numbers from one or more sports or other events. In the embodiment illustrated in FIG. 6, each team in a slate of football games is assigned a game number. The 5 winning teams which score the most points are defined to be the winning teams, and the winning numbers are the numbers assigned to those winning teams.

As described above and as indicated in FIG. 6, a wide variety of other criteria may be used for defining the winning numbers, such as losing teams scoring the fewest points, teams scoring the most points and teams scoring the fewest points. As also indicated above, the criteria may vary dependent upon the particular event.

The outcome of the game is determined by comparing the winning numbers to the player's numbers. A winning outcome is received if one or more combinations of player numbers match the winning numbers.

In the preferred embodiment, the game is implemented as a wagering game. A player places a bet or wager to play the game. In one embodiment, a player places a bet to obtain a set of player numbers (such as a player card).

If the player receives a winning outcome, the player may be paid winnings. In one embodiment, some or all of the wagers placed by players are put into a jackpot pool. In one embodiment, a player is only the winner if all of the game numbers match his or her player numbers. Each or all players receiving such a winning combination takes (or shares) the jackpot pool.

Other criteria may be applied, however, for paying winnings. For example, a player may be paid pre-set or predefined winnings. A player may receive winnings for matching less than all of the winning numbers. For example, a player might be paid $X for matching all but two winning numbers, and a larger $Y for matching all but one winning number. Such winnings may also be funded from a portion of the wagers.

As illustrated, a lottery type card or receipt may be provided to a player. The lottery type card may be printed with randomly selected player numbers from the set of game numbers. In one embodiment, a player may also be permitted to select one or more of the player numbers.

In another embodiment, the game could be implemented in video form. For example, player numbers could be displayed on a video display.

A wide variety of apparatus, including systems, may be used to implement the game. In one embodiment, a computer generates set of player numbers. The generated information is used to print player lottery tickets or cards. The generated data sets are stored. Input is provided regarding the winning numbers and those numbers are compared to the stored data sets to confirm wins. A player may be required to turn in his or her lottery card in order to claim his or her winnings. In another embodiment, information regarding the identity of the player placing the wager may be associated with the player number data (such as at the time the wager is placed) and that information may be used to identify the winner or winner(s) of the invention.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A method of playing a game comprising the steps of:
providing a set of game numbers to be used in the play of a game;
selecting from said set of numbers a set of player numbers applicable to a player;
determining the outcome of one or more sporting events;
generating a set of winning numbers based upon the outcome of said one or more sporting events;
comparing said set of winning numbers to said set of player numbers; and
declaring one or more winners of said game dependent upon matches of said set of winning numbers to said set of player numbers.

2. The method in accordance with claim 1 wherein said game is implemented as a Keno-style game wherein said set of game numbers to be used in the play of said game are printed on a game card and said player numbers are selected by marking one or more of said set of game numbers printed on said game card.

3. The method in accordance with claim 1 wherein said game is implemented as a Bingo-style game wherein said set of player numbers is displayed in a grid format and wherein a player is a winner of said game if one or more predetermined patterns of player numbers match said winning numbers.

4. The method in accordance with claim 3 wherein said set of player numbers is printed on a game card.

5. The method in accordance with claim 1 wherein said game is implemented as a lottery-style game in which said set of player numbers is selected as a sequential group of numbers.

6. The method in accordance with claim 1 wherein said set of numbers comprises a set of sequential numbers between a first value and a second value.

7. The method in accordance with claim 1 wherein said one or more sporting events comprise one or more events in which participants play one another for a score.

8. The method in accordance with claim 7 wherein said winning numbers are determined by said scores of one or more of said sporting events.

9. The method in accordance with claim 7 wherein said winning numbers comprise a total score of two participants playing one another in each of said sporting events.

10. The method in accordance with claim 9 wherein said winning numbers comprise a set of the highest total scores of two participants playing one another in said sporting events.

11. The method in accordance with claim 1 wherein said player numbers are selected by the player.

12. The method in accordance with claim 1 including the step of accepting a wager by a player to play said game and wherein if said player is a winner of said game, said player is paid a winning amount.

13. The method in accordance with claim 12 wherein said game is a multi-player game and includes the step of selecting a plurality of sets of player numbers corresponding to a plurality of players.

14. The method in accordance with claim 13 wherein said one or more winners of said game comprise the one or more players having the most player numbers matching said winning numbers.

15. The method in accordance with claim 1 wherein said set of player numbers and said set of winning numbers comprises a sub-set of less than all of said set of game numbers used to play said game.
